(19) United States
(12) Patent Application Publication
(10) Pub. No.: US 2018/0315019 A1
(43) Pub. Date: Nov. 1, 2018

(54) MULTINODAL JOB-SEARCH CONTROL SYSTEM

(71) Applicant: LinkedIn Corporation, Sunnyvale, CA (US)

(72) Inventors: KRISHNARAM KENTHAPADI, Sunnyvale, CA (US); Kaushik Rangadurai, Sunnyvale, CA (US)

(21) Appl. No.: 15/499,594

(22) Filed: Apr. 27, 2017

(51) Int. Cl. G06Q 10/10; G06F 17/30; G06N 99/00; G06Q 50/00

(52) U.S. Cl. CPC G06Q 10/1053; G06F 17/3053; G06Q 50/01; G06N 99/005; G06F 17/30554

(57) ABSTRACT

Methods, systems, and computer programs are presented for presenting search results based on search classification sets to a member. A method includes defining a search query for the member based on a search request for the member, distributing the search query to searching nodes for searching an index, receiving job results from the searching nodes, determining a set of search classification sets based on a relevance of the job results to job characteristics, ranking the job results based on the search classification sets, and presenting the ranked job results to the member. The method may further include applying a Boolean predicate to the search query based on a member profile.

### TECHNICAL FIELD

The subject matter disclosed herein generally relates to methods, systems, and programs for searching jobs on a social network.

### BACKGROUND

Some social networks provide job postings to their members. The member may perform a job search by entering a job search query, or the social network may suggest jobs that may be of interest to the member. However, current job search methods may miss valuable opportunities for a member because the job search engine limits the search to specific parameters. For example, the job search engine may look for matches of a job title to the member's title or profile, but there may be quality jobs that are associated with a different title that would be of interest to the member.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a network architecture for a search query management system, according to some example embodiments, including a social networking server.

FIG. 2 is a screenshot of a user interface that includes recommendations for job results, according to some example embodiments.

FIG. 3 is a screenshot of a member's profile view, according to some example embodiments.

FIG. 4A illustrates the scoring of a job result for a member, according to some example embodiments.

FIG. 4B further shows the scoring of the job result for the member while incorporating search classification sets, according to some embodiments.

FIG. 5 illustrates the training and use of a machine-learning program, according to some example embodiments.

FIG. 6A illustrates a method for ranking job results based on search classification sets in some example embodiments.

FIG. 6B illustrates ranking search classifications sets based on job results, according to some example embodiments.

FIG. 7 further illustrates operations for ranking job results based on search classification sets, according to some example embodiments.

FIG. 8 illustrates an alternative embodiment of the method for ranking job results based on search classification sets, in some example embodiments.

FIG. 9 illustrates a search query management system for implementing example embodiments.

FIG. 10 is a flowchart of a method, according to some example embodiments, for ranking job results based on search classification sets.

FIG. 11 is a block diagram illustrating an example of a software architecture that may be installed on a machine, according to some example embodiments.

FIG. 12 is a diagrammatic representation of a machine in the form of a computer system within which a set of instructions may be executed for causing the machine to perform any one or more of the methodologies discussed herein, according to an example embodiment.

### DETAILED DESCRIPTION

Example methods, systems, and computer programs are directed to refining search results based on search classification sets for presentation to a user. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

One of the goals of the present embodiments is to personalize and redefine how job postings are searched and presented to job seekers. Another goal is to explain better why particular candidate jobs are recommended to the job seekers. The presented embodiments provide a method for retrieving search results from a member search and organizing these results based on search classification sets.

Instead of providing a single job recommendation list for a member, embodiments presented herein expose the member to job recommendations that have characteristics relevant to the member. A job characteristic, as used herein, indicates the relevance of a job to a search classification set (e.g., “frequently viewed jobs”). In some example embodiments, the job characteristics are associated with one or more attributes of the job result, such as the age of the job result, the size of an applicant pool that has already applied to the job result, or the frequency of recommendation of the job result among all members.

In some example embodiments, a search classification is a logical set of rules used to identify a job-related feature that is important to the member for selecting jobs. Jobs comporting with these rules may be placed in a search classification set of the search classification. Job-related features include, for example, how many people have transitioned from the university of the member to the company of the job, who would be a virtual team for the member if the member joined the company, etc. Thus, the member is given insight into why certain jobs are presented within a particular group associated with the feature of the search classification set.

Embodiments presented herein provide a network architecture for a search query management system to evaluate jobs, search classification sets, and members to determine a personalized display of jobs to a member that best conforms with the member's employment interests. The search classification sets can be ranked based on the job results found within each classification set. Further, the job results can be ranked based the ranking of their search classification sets.

One general aspect includes a method for detecting a job search request for a member of a social network. A search request for a member may be physically initiated by the member or initiated by a system on behalf of the member in order to automatically provide results (e.g., by email or in response to the member logging into the social network). The method includes defining a query object based on the job search request, identifying a set of searching nodes that are each associated with a partition of an index of a jobs database, and sending the query to the searching nodes. The method also includes receiving job results from the searching nodes and, for each job result, calculating a classification affinity score for a plurality of search classification sets. The classification affinity score is based on a relevance of the job result to job characteristics associated with the search classification. The method then identifies a prioritized set of search classification sets based on the classification affinity scores for each of the search classification sets. Finally, the method ranks the job results for each of the search classification sets of the prioritized set of search classification sets based on classification affinity scores of the job results for each of the prioritized search classification sets and causes presentation of the ranked job results in a user interface of the member.

In some embodiments, defining a query object includes identifying at least one Boolean predicate, the Boolean predicate being one or more logical terms included to the query. In some embodiments, the Boolean predicate has a probabilistic weight that further dictates the degree of consideration of the Boolean predicate within the query. In some embodiments, the Boolean predicate is identified based on a value within the member data of the member profile exceeding a threshold value. In some embodiments, the job result is further based on a matching degree between the query object and the job result. In some embodiments, the method further includes calculating a member-characteristic score between the member and each of the job characteristics that is based on a similarity between the member and the respective job characteristic, and where the member-characteristic score can further be used to identify the prioritized set of search classification sets.

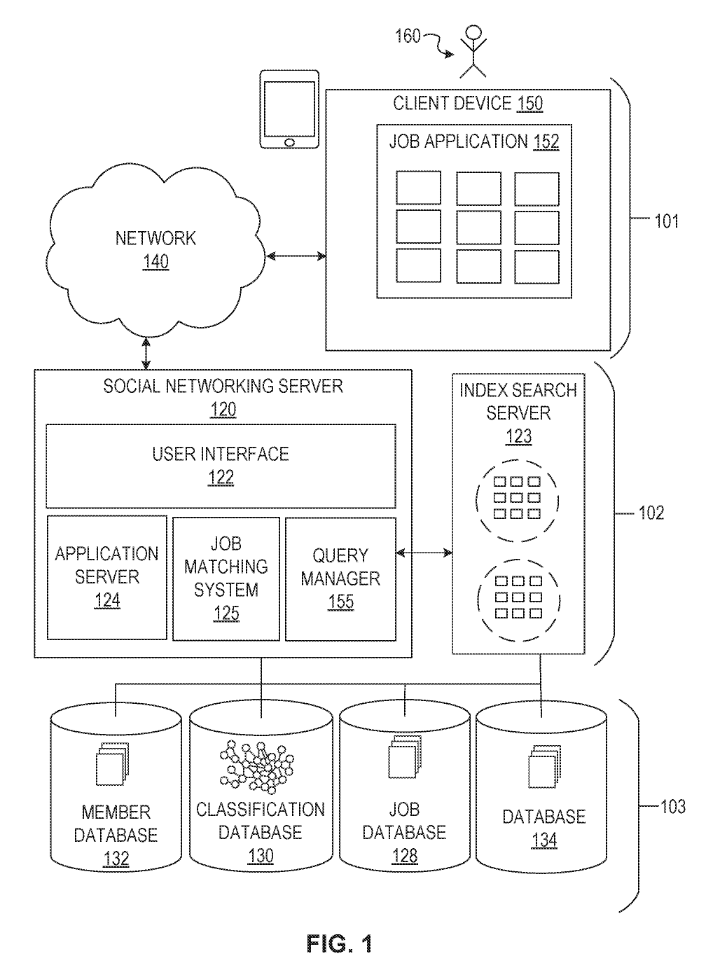

FIG. 1 is a block diagram illustrating a network architecture, according to some example embodiments, including a social networking server 120 and a network 140 (e.g. the internet). As shown in FIG. 1, a data layer 103 includes several databases, including a member database 132 for storing data accessible to the social networking server 120 and an index search server 123, including member profiles, company profiles, and educational institution profiles, as well as information concerning various online or offline groups. Of course, in various alternative embodiments, any number of other entities might be included in the social graph, and as such, various other databases may be used to store data corresponding with other entities.

Consistent with some embodiments, when a person initially registers to become a member of the social networking server 120, the person will be prompted to provide some personal information, such as his or her name, age (e.g., birth date), gender, interests, contact information, home town, address, spouse's and/or family members' names, educational background (e.g., schools, majors, etc.), current job title, job description, industry, employment history, skills, professional organizations, interests, and so on. This information is stored, for example, as member attributes in the member database 132. According to some embodiments, the member database 132 includes member data that is used to bolster a search for a member in order to retrieve more relevant search results. The social networking server 120 also communicates with the index search server 123 to distribute searches and receive search result output.

Additionally, the data layer 103 includes a job database 128 for storing job data. The job data includes information collected from a company offering a job, including experience required, location, duties, pay, and other information. This information is stored, for example, as job attributes in the job database 128.

Once registered, a member may invite other members, or be invited by other members, to connect via the social networking server 120. A “connection” may specify a bilateral agreement by the members, such that both members acknowledge the establishment of the connection. Similarly, in some embodiments, a member may elect to “follow” another member. In contrast to establishing a connection, the concept of “following” another member typically is a unilateral operation, and at least in some embodiments, does not prompt acknowledgement or approval by the member who is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking server 120. In some example embodiments, because the content selection algorithm selects content relating to or associated with the particular entities that a member is connected with or is following, as a member connects with and/or follows other entities, the universe of available content items for presentation to the member in his or her content stream increases.

Additionally, the data layer 103 includes a classification database 130 for storing search classification set data. The classification database 130 includes information about jobs that have job attributes in common with each other. The search classification set data includes various job features comprising at least one job characteristic that indicates a relevance to a search classification, as discussed in more detail below. This information is stored, for example, as job attributes in the job database 128.

Additionally, in some embodiments, the data layer 103 includes various other databases 134 for storing additional information that can be accessed by the social networking server 120 or the index search server 123.

As members interact with various applications, content, and user interfaces of the social networking server 120, information relating to the members' activity and behavior may be stored in a database, such as the member database 132 and the job database 128.

The social networking server 120 may provide a broad range of other applications and services that allow members the opportunity to share and receive information, often customized to the interests of the members. In some embodiments, members of the social networking server 120 may be able to self-organize into groups, or interest groups, organized around subject matter or a topic of interest. In some embodiments, members may subscribe to or join groups affiliated with one or more companies. For instance, in some embodiments, members of the social networking server 120 may indicate an affiliation with a company at which they are employed, such that news and events pertaining to the company are automatically communicated to the members in their personalized activity or content streams. In some embodiments, members may be allowed to subscribe to receive information concerning companies other than the company with which they are employed. Membership in a group, a subscription or following relationship with a company or group, and an employment relationship with a company are all examples of different types of relationship that may exist between different entities, as defined by the social graph and modeled with social graph data of the member database 132.

An application logic layer 102 includes the index search server 123 and the social networking server 120. The index search server 123 includes a plurality of searching nodes that are each associated with a partition of a job index. In some example embodiments, the job index for the jobs database 128 is partitioned into several partitions, and each of the partitions is managed by one of the searching nodes. Each searching node may include one or more programs for searching a partition of the job index for the jobs database 128. Each searching node may execute on a different server, or several searching nodes may execute on the same server. The searching nodes are each configured for searching the associated partition of the job index and returning job results.

The social networking server 120 further includes various application server modules 124, which, in conjunction with a user interface module 122, generate various user interfaces with data retrieved from various data sources or data services in the data layer 103. In some embodiments, individual application server modules 124 are used to implement the functionality associated with various applications, services, and features of the social networking server 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling members to search for and browse member profiles may be implemented with one or more application server modules 124. Of course, other applications and services may be separately embodied in their own application server modules 124. As illustrated in FIG. 1, the social networking server 120 may include a job matching system 125, which creates a job display that is displayed within a job application 152 on a client device 150, such as a smartphone or personal computer. Also included in the social networking server 120 is a query manager 155 that distributes search queries and receives and query results based on search classification sets. These portions of the system that are visible to the member 160 are part of an application layer 101.

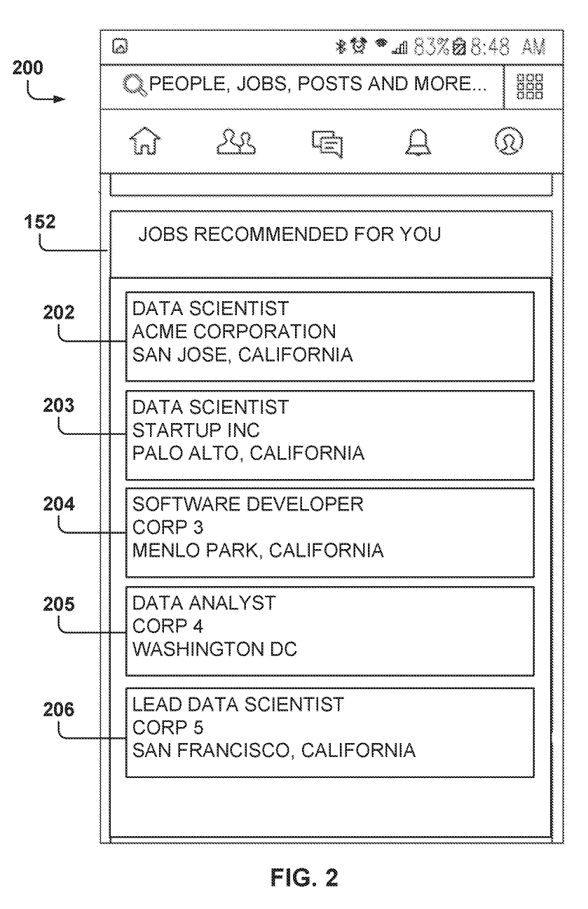

FIG. 2 is a screenshot of a user interface 200 that includes recommendations for job results 202-206 within the job application 152, according to some example embodiments. In one example embodiment, the social network user interface 200 within the job application 152 on the client device 150 provides job recommendations, which are job postings that match the job interests of the member and that are presented without a specific job search request from the member (e.g., job suggestions).

In another example embodiment, a job search interface is provided for entering job searches, and the resulting job matches are presented to the member in the user interface 200.

As the member scrolls down the user interface 200, more job results 202-206 are presented to the member. In some example embodiments, the job recommendations are prioritized to present jobs in an estimated order of interest to the member.

The user interface 200 presents a “flat” list of job results 202-206 as a single list. Other embodiments presented below utilize a “segmented” list of job recommendations where each segment is a group that is associated with a related reason indicating why these jobs are being recommended within the group.

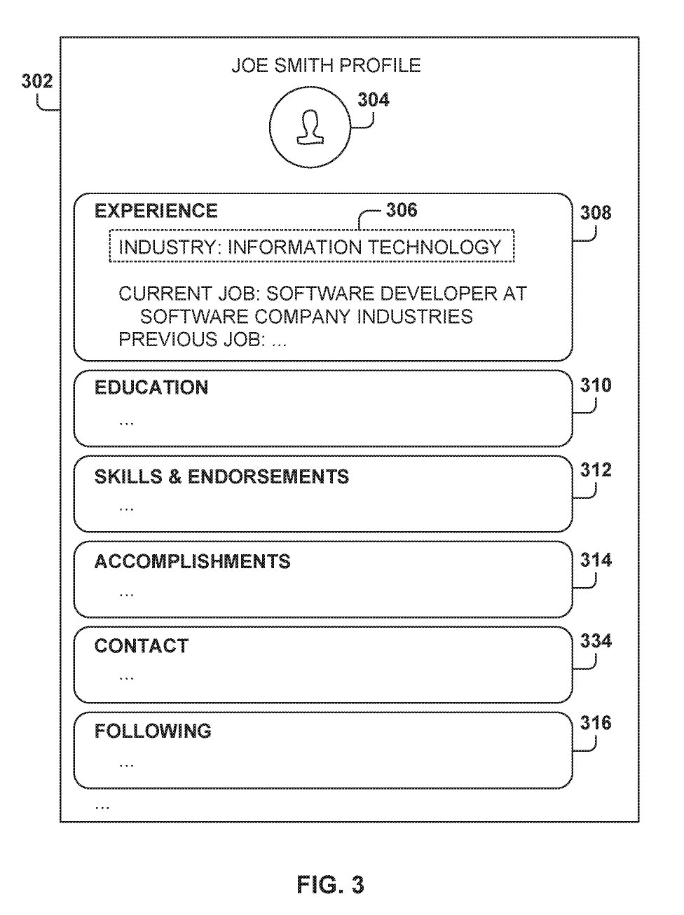

FIG. 3 is a screenshot of a member's profile view, according to some example embodiments. Each member in the social network has a member profile 302, which includes information about the member. The member profile 302 is configurable by the member and also includes information based on the member's activity in the social network (e.g., likes, posts read).

In one example embodiment, the member profile 302 may include information in several categories, such as a profile picture 304, experience 308, education 310, skills and endorsements 312, accomplishments 314, contact information 334, following 316, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the member's account is associated with the number of endorsements received for each skill from other members.

The experience 308 information includes information related to the professional experience of the member. In one example embodiment, the experience 308 information includes an industry 306, which identifies the industry in which the member works. In one example embodiment, the member is given an option to select an industry 306 from a plurality of industries when entering this value in the member profile 302. The experience 308 information area may also include information about the current job and previous jobs held by the member.

The education 310 information includes information about the educational background of the member, including the educational institutions attended by the member, the degrees obtained, and the field of study of the degrees. For example, a member may list that the member attended the University of Michigan and obtained a graduate degree in computer science. For simplicity of description, the embodiments presented herein are presented with reference to universities as the educational institutions, but the same principles may be applied to other types of educational institutions, such as high schools, trade schools, professional training schools, etc.

The skills and endorsements 312 information includes information about professional skills that the member has identified as having been acquired by the member, and endorsements entered by other members of the social network supporting the skills of the member. The accomplishments 314 area includes accomplishments entered by the member, and the contact information 334 includes contact information for the member, such as an email address and phone number. The following 316 area includes the names of entities in the social network being followed by the member. In some example embodiments, the member profile 302 is used to build member data within the member database 132.

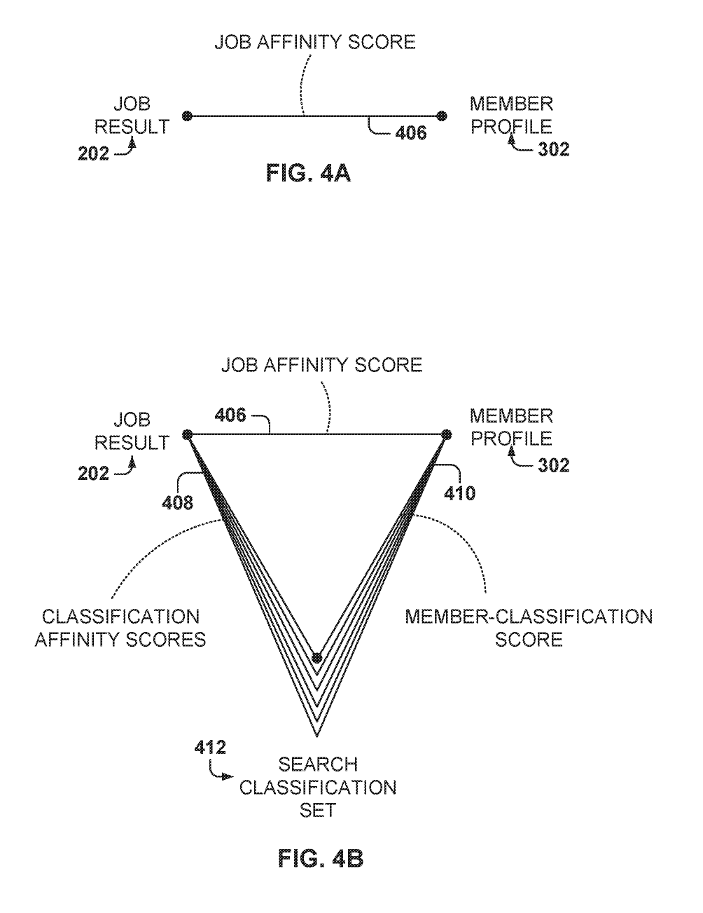

FIG. 4A illustrates the scoring of a job result for a member, according to some example embodiments. A job affinity score 406, between a job result 202 and a member associated with the member profile 302, is a value that measures how well the job result 202 matches the interest of the member in finding the job result 202. A so-called “dream job” for a member would be the perfect job for the member and would have a high, or even maximum, value, while a job that the member is not interested in at all (e.g., in a different professional industry) would have a low job affinity score 406. In some example embodiments, the job affinity score 406 is a value between zero and one, or a value between zero and 100, although other ranges are possible.

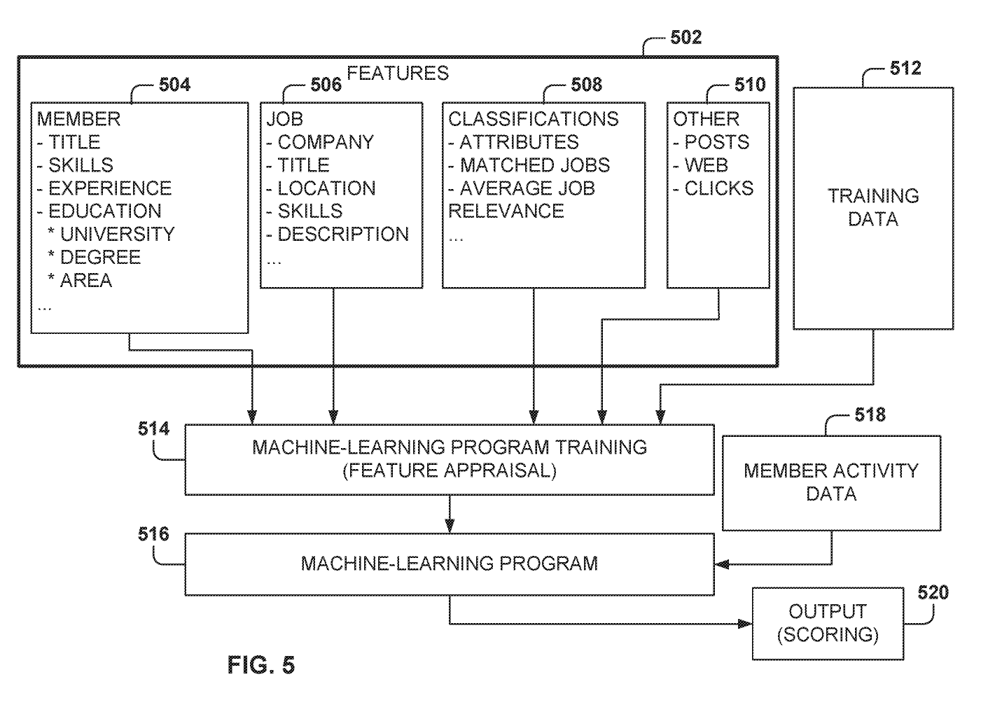

In some example embodiments, a machine-learning program is used to calculate the job affinity scores 406 for the job results 202 available to the member. The machine-learning program is trained with existing data in the social network, and the machine-learning program is then used to evaluate job results 202 based on the features used by the machine-learning program. In some example embodiments, the features include any combination of job data (e.g., job title, job description, company, geographic location, etc.), member profile data, member search history, employment of social connections of the member, job popularity in the social network, number of days the job has been posted, company reputation, company size, company age, company type (profit vs. nonprofit), and pay scale. More details are provided below with reference to FIG. 5 regarding the training and use of the machine-learning program.

FIG. 4B further shows the scoring of the job result for the member while incorporating search classification sets, according to some embodiments. Specifically, FIG. 4B illustrates the scoring of a job result 202 for a member associated with the member profile 302, according to some example embodiments, based on three parameters: the job affinity score 406, a classification affinity score 408, and a member-classification score 410. Broadly speaking, the job affinity score 406 indicates how relevant the job result 202 is to the member, the classification affinity score 408 indicates how relevant the job result 202 is to a search classification set 412, and the member-classification score 410 indicates how relevant the search classification set 412 is to the member.

The member-classification score 410 indicates how relevant the search classification set 412 is to the member, where a high member-classification score 410 indicates that the search classification set 412 is very relevant to the member and should be presented in the user interface, while a low member-classification score 410 indicates that the search classification set 412 is not relevant to the member and may be omitted from presentation in the user interface.

The member-classification score 410 is used, in some example embodiments, to determine which search classification sets 412 are presented in the user interface, as discussed above, and the member-classification score 410 is also used to order the search classification sets 412 when presenting them in the user interface, such that the search classification sets 412 may be presented in the order of their respective member-classification scores 410. It is to be noted that if there is not enough “liquidity” of jobs for a search classification set 412 (e.g., there are not enough jobs for presentation in the search classification set 412), the search classification set 412 may be omitted from the user interface or presented with lower priority, even if the member-classification score 410 is high.

In some example embodiments, a machine-learning program is utilized for calculating the member-classification score 410. The machine-learning program is trained with member data, including interactions of members with the different search classification sets 412. The data for the particular member is then utilized by the machine-learning program to determine the member-classification score 410 for the member with respect to a particular search classification set 412. The features utilized by the machine-learning program include the history of interaction of the member with jobs from the search classification set 412, click data for the member (e.g., a click rate based on how many times the member has interacted with the search classification set 412), member interactions with other members who have a relationship to the search classification set 412, etc. For example, one feature may include an attribute that indicates whether the member is a student. If the member is a student, features such as social connections or education-related attributes will be important to determine which search classification sets 412 are of interest to the student. On the other hand, a member who has been out of school for 20 years or more may not be as interested in education-related features.

Another feature of interest to determine member-classification scores 410 is whether the member has worked in small companies or large companies throughout a long career. If the member exhibits a pattern of working for large companies, a search classification set 412 that is associated with jobs for large companies would likely be of more interest to the member than a search classification set 412 that is associated with jobs in small companies, unless there are other factors, such as recent interaction of the member with jobs from small companies.

The classification affinity score 408 between a job result 202 and a search classification set 412 indicates the job result's 202 strength within the context of the search classification set 412, where a high classification affinity score 408 indicates that the job result 202 is a good candidate for presentation within the search classification set 412 and a low classification affinity score 408 indicates that the job result 202 is not a good candidate for presentation within the search classification set 412. In some example embodiments, a predetermined threshold is identified, wherein job results 202 with a classification affinity score 408 equal to or above the predetermined threshold are included in the search classification set 412, and job results 202 with a classification affinity score 408 below the predetermined threshold are not included in the search classification set 412.

For example, in a search classification set 412 that presents jobs within the social network of the member, if there is a job result 202 for a company within the network of the member, the classification affinity score 408 indicates how strong the member's network is for reaching the company of the job result 202.

FIG. 5 illustrates the training and use of a machine-learning program 516, according to some example embodiments. In some example embodiments, machine-learning programs, also referred to as machine-learning algorithms or tools, are utilized to perform operations associated with job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 512 in order to make data-driven predictions or decisions expressed as outputs or assessments (e.g., a score) 520. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

In general, there are two types of problems in machine learning: classification problems and regression problems. Classification problems aim at classifying items into one of several categories (for example, is this object an apple or an orange?). Regression algorithms aim at quantifying some items (for example, by providing a value that is a real number). In some embodiments, example machine-learning algorithms provide a job affinity score 406 (e.g., a number from 1 to 100) to qualify each job as a match for the member (e.g., calculating the job affinity score). In other example embodiments, machine learning is also utilized to calculate the member-classification score 410 and the classification affinity score 408. The machine-learning algorithms utilize the training data 512 to find correlations among identified features 502 that affect the outcome.

In one example embodiment, the features 502 may be of different types and may include one or more of member features 504, job features 506, classification features 508, and other features 510. The member features 504 may include one or more of the data in the member profile 302, as described in FIG. 3, such as title, skills, experience, education, etc. The job features 506 may include any data related to the job result 202, and the classification features 508 may include any data related to search classification sets. In some example embodiments, additional features in the other features 510 may be included, such as post data, message data, web data, click data, etc.

With the training data 512 and the identified features 502, the machine-learning tool is trained at operation 514. The machine-learning tool appraises the value of the features 502 as they correlate to the training data 512. The result of the training is the trained machine-learning program 516.

When the machine-learning program 516 is used to generate a score, new data, such as member activity 518, is provided as an input to the trained machine-learning program 516, and the machine-learning program 516 generates the score 520 as output. For example, when a member performs a job search, a machine-learning program, such as the machine-learning program 516, trained with social network data, uses the member data and job data from the jobs in the database to search for jobs that match the member's profile and activity.

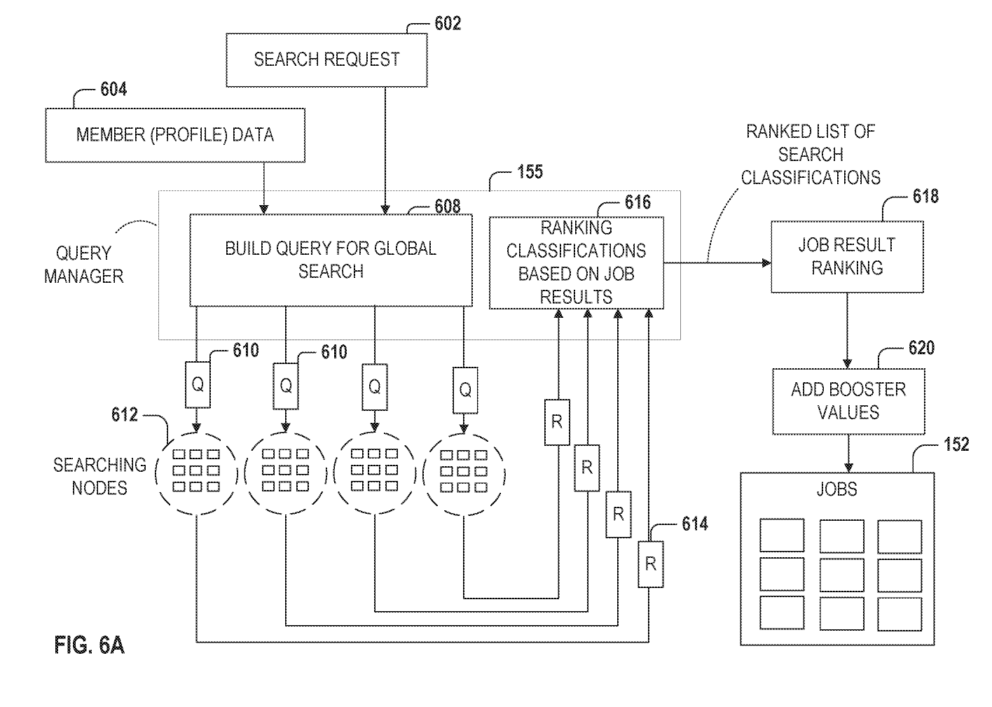

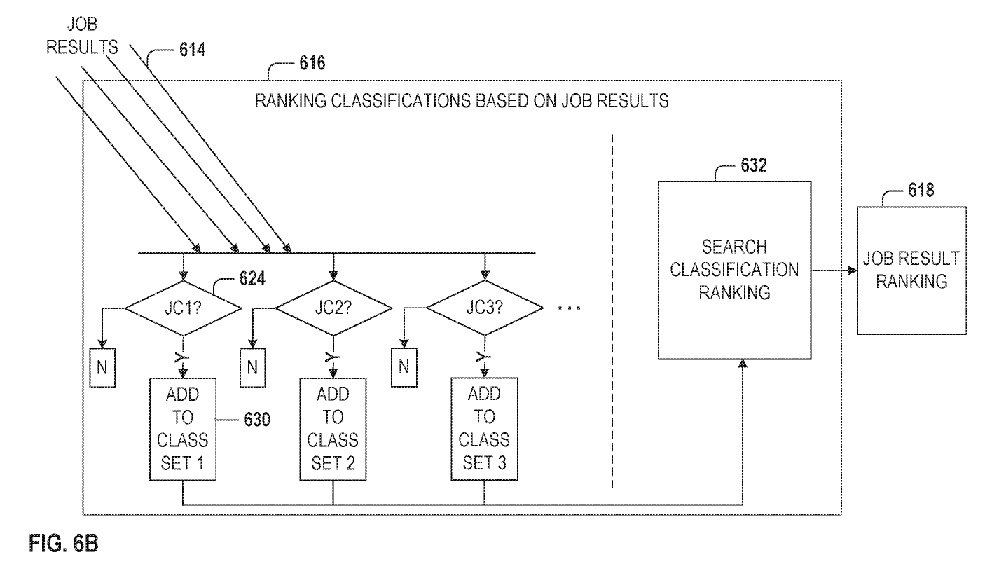

FIG. 6A illustrates a method for ranking job results based on search classification sets, in some example embodiments. A search request 602 is received. The search request 602 may be initiated by the member 160, such as by navigating to a “recommended jobs” page on a user interface, or may be initiated by the system to suggest jobs to the member 160. Alternatively, the system may perform a search in response to an event. In an example, the member 160 changes his member profile to reflect the member 160 moving from San Francisco to San Diego and, in response to this change, the system performs a search for jobs in San Diego.

The system then accesses member data 604, such as from a member profile 302 associated with the member 160, to build a query for the search request 608. In some example embodiments, a query manager 155 accesses the member data 604 that includes a plurality of Boolean predicates. As used herein, a Boolean predicate is a term that alters a search query, thus rendering different results than if the query was searched without the Boolean predicate.

In an example, the member searches for “Computer Programming Jobs in San Jose.” The system determines that the member has worked 12 years as a computer programmer, and this value exceeds a threshold value of 8 years used by the search system to trigger the addition of “Senior” (e.g., “Senior computer programmer) to the search. In response to the threshold being exceeded, the system adds the Boolean predicate “Senior in title” to “Computer Programming Jobs.”

The system determines one or more Boolean predicates that should be used with the search based on the member data 604. In some example embodiments, the Boolean predicate is applied by the system based on a value within the member data 604 exceeding a threshold predicate value located in the other database 134.

In some embodiments, the Boolean predicate is probabilistic, as the Boolean Predicate is based on a probability that a condition is true being above a predetermined threshold. For example, the Boolean predicates can be weighted based on a matching degree between the member data 604 and the search request 608. An example of a probabilistic weighting equation Wᵢ would be:

Wᵢ=Xmax(1,i−T+1)

In the above equation, X represents a minimum weighting constant that is applied to the Boolean predicate. T is the threshold value for applying the Boolean predicate, and i is the value within the member data 604. Thus, the weighting will remain equal to the minimum weighting constant if i is equal to T and will increase as i increases relative to T.

Continuing the “computer programming” example above, the system may apply a higher weighting factor (e.g., 0.643), to the predicate based on the 12 years of experience, than the minimum factor (e.g., 0.245) that would be applied if the member had been a computer programmer for 8 years or less.

The query manager 155 distributes a search query 610 to a plurality of searching nodes 612. A searching node 612 is a program configured to search through a partition of the job index based on the search query. In some example embodiments, the index is a reverse index that includes all jobs posted on the social networking server, the jobs accessible from the job database 128. In some example embodiments, the system employs a machine-learning program 516 to determine job results that have a significant matching degree with the search query 610.

In some example embodiments, the searching nodes 612 are pre-ranked based on member activity associated with the respective partition of the index. In some embodiments, member activity includes applications submitted by the searching member 160 to job results provided by the respective partition of the index, views of job results from the partition of the index, or shares of job results from the partition of the index. In some example embodiments, the system ranks the searching nodes 612 by calculating a level of member activity for each partition of the index and then ranks the respective searching nodes 612 in order from highest to lowest. Further, in some embodiments, the rank of the searching node 612 may later affect a ranking of search classification sets, such as by causing a first search classification set that includes a first job result from a first searching node 612 to be ranked above a second search classification set that includes a second job result from a second searching node 612, where the first searching node 612 is ranked higher than the second searching node 612. The query manager 155 then receives a plurality of job results 614 from the searching nodes 612. At operation 616, the classification sets are ranked according to job results that are included within the classification sets, as detailed in FIG. 6B.

At operation 618, the system ranks the job results 614 based on the ranked list of search classification sets. In some example embodiments, this ranking of the job results 614 is essentially a “re-ranking”, since the job results 614 have already been ranked by the searching nodes 612. In some example embodiments, job results 614 are ranked based on multiple factors, such as how many search classification sets 630 the job results 614 are included in and how high on the ranked list of search classification sets these search classification sets 630 appear. In some example embodiments the “re-ranking” is further based on one or more of the scores from the machine-learning program 516, such as the job affinity score 406 between each job result 202 and the member profile, the member-classification score 410 between the member profile 302 and the search classification set 412, and the classification affinity score 408 between the job result 202 and the search classification set 412.

At operation 620, various booster values may be added to the ranked job results 614, causing some movement in the ranking. Booster values include a priority factor for certain job results 614 due to other factors not related to the member 160. For example, if a first company offering a first job result 614 is paying for a premium listing, the first job result 614 may be ranked over a second job result 614 that is offered by a second company not paying for a premium listing. Finally, the ranked job results 614 are displayed to the member through the job application 152.

FIG. 6B illustrates sub-operations and related components of operation 616 of FIG. 6A. Each of the job results 614 is compared to job characteristics 624 to determine whether the job result 614 belongs in a search classification set 630. In some example embodiments, a job result 614 being within a search classification set 630 is based on the job result 614 meeting a minimum threshold of applicability to the job characteristic 624. In some example embodiments, the job result 614 may apply to multiple job characteristics 624 and each job characteristic 624 may place the job result 614 in multiple search classification sets 630. Similarly, a search classification set 630 may receive job results 614 from multiple job characteristics 624.

For example, a search classification set for “Senior Manager” is associated with a job characteristic that job applicants must have at least 5 years of managerial experience. If a first job result has an application requirement that job applicants have 7 years of managerial experience, this would exceed the threshold set by the job characteristic and thus the first job result would be included in the search classification. In contrast, a second job result that has an application requirement that applicants for the job have only 2 years of managerial experience would not fulfill the job characteristic and thus would not be placed in the search classification.

Once the search classification sets 630 receive the job results 614 that match the job characteristics 624, the system determines an affinity score for each of the search classification sets 630, determines a set of the search classification sets 630 based on the affinity scores, and ranks the set. The affinity scores for the search classification sets 630 may be combinations, such as by summation or by averaging, of the classification affinity scores 408 shown in FIG. 4B and may be based on the job results 614 contained in the search classification sets 630.

In some example embodiments, the determination of the set of search classification sets is performed based on a threshold affinity score for the search classification sets, retrieved from a database 134. For example, where the threshold classification affinity score is 20.89, a first search classification set 630 with an affinity score of 49.36 would exceed the threshold and be included in the search classification set, and a second search classification set 630 with an affinity score of 17.86 would not exceed the threshold and would not be included in the search classification set.

In some example embodiments, the set of search classification sets is determined based on the affinity scores, the number of job results in the classifications, the quality (ranking) of each of the job results by the respective searching nodes within the search classification sets, or a combination of these factors. At operation 632, once the set of search classification sets is selected, a ranked list of the search classification sets is determined based on the classification affinity scores of the search classification sets. For example, the system would place a first search classification set with a classification affinity score of 62.56 above a second search classification set having a classification affinity score of 46.25. In some example embodiments, the ranking is further based on the member-classification scores 410 as determined between the member profile 302 and the respective search classification. The calculation of all scores discussed in this section may be performed by comparing similarity values calculated using the machine-learning program 516.

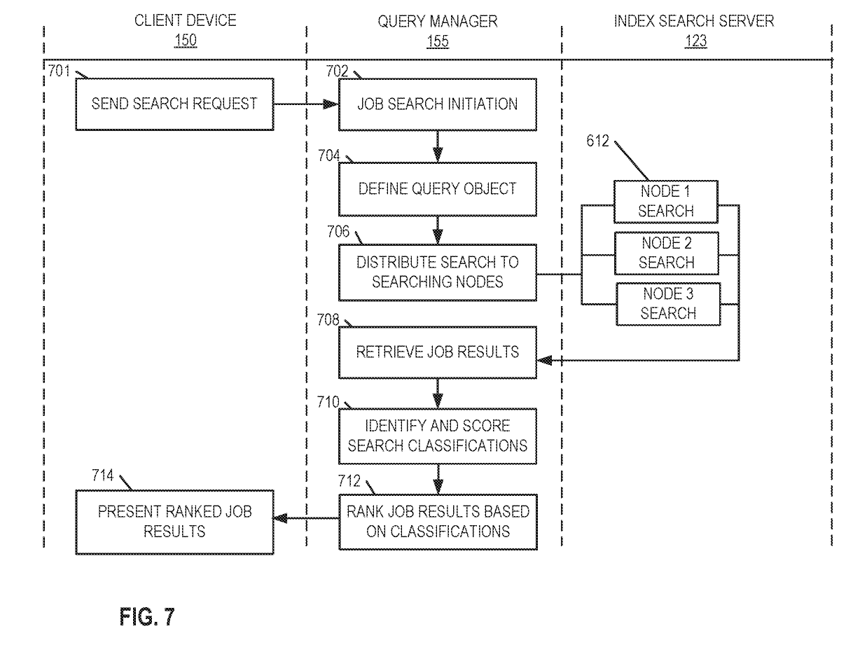

FIG. 7 further illustrates operations for ranking job results based on search classification sets, according to some example embodiments. Shown are three computer devices in FIG. 1 that carry out the operations, according to some example embodiments: the client device 150, the query manager 155, and the index search server 123. At operation 701, the client device 150 receives an indication to initiate a search (search request). In some example embodiments, the search request is in response to an actual search input by the member 160. In some example embodiments, the search request is an automatic request caused by other devices, such as the member 160 changing his or her current residence.

At operation 702, the query manager 155 receives the search request 602 and initiates the job search. In some example embodiments, operation 702 includes accessing one or more of the databases, such as the member database 132, to retrieve data, such as data related to the member profile 302. In response to accessing this data, at operation 704, the query manager 155 builds a query object based on the data accessed as well as the search request 602. As stated above, in some embodiments, the data accessed can include a probabilistic predicate to apply to the search query.

At operation 706, the query manager 155 distributes the query object to each of the searching nodes 612 located within the index search server 123, where each searching node 612 accesses one of a plurality of partitions of an index. At operation 708, the index search server 123 returns job results from each of the searching nodes 612 to the query manager 155.

At operation 710, the query manager 155 identifies a prioritized set of search classification sets by determining which search classification sets include job results based on one or more job characteristics. The query manager 155 assigns a classification affinity score to each of the search classification sets based on the number and quality of job results within each search classification.

At operation 712, the query manager 155 ranks the job results based on the classification affinity scores of the search classification sets associated with each job result, such as by placing a job result belonging to a search classification set with a higher classification affinity score ahead of a job result belonging to a search classification set with a lower classification affinity score. At operation 714, the query manager 155 sends a ranked list of job results to the job application 152, which causes a display of the job results on a user interface of the member 160.

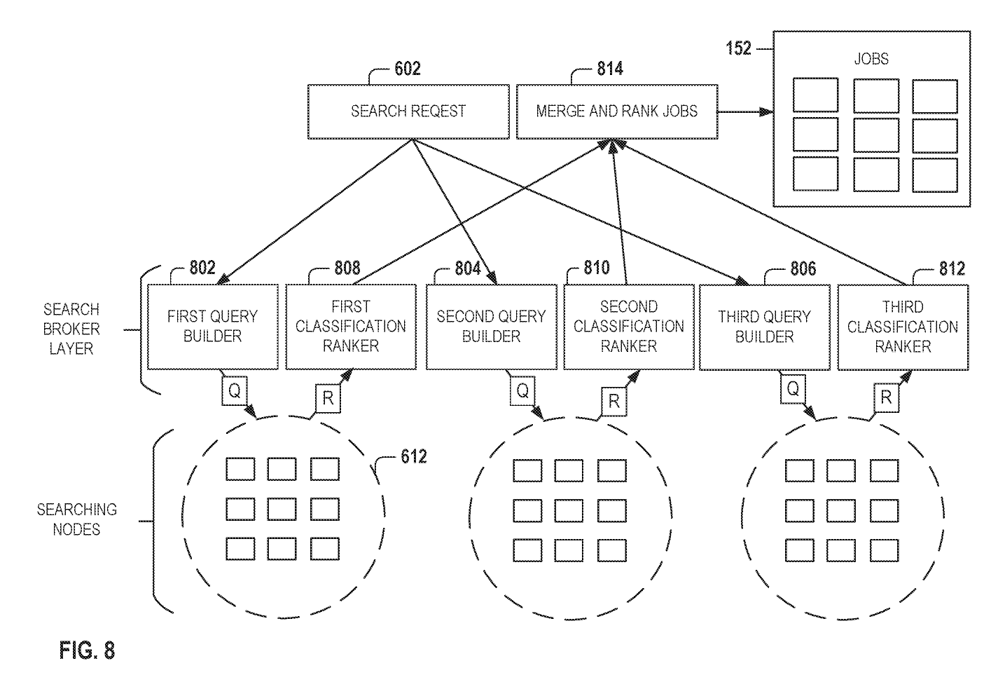

FIG. 8 illustrates an alternative embodiment of the method for ranking job results based on search classification sets, in some example embodiments. In some example embodiments, the query manager 155 is distributed into a search broker layer that includes multiple query builders 802, 804, 806 and search classification set rankers 808, 810, 812, where each query builder is associated with a corresponding searching node 612.

As in the method of FIG. 6A, a search request 602 is first detected for the user. Next, the search request 602 is distributed to multiple query builders, such as a first query builder 802, a second query builder 804, and a third query builder 806. Each of the query builders develops a customized query for the respective searching node 612. Although the embodiment of FIG. 8 is presented with reference to three searching nodes, other embodiments may utilize different number of searches nodes, such as a number of searching nodes in a range from 2 to 100.

In some example embodiments, the search query is constructed based on member activity corresponding to results provided by the searching node 612. For example, the first query builder 802 may access the member profile 302 and retrieve data indicating that the member 160 has viewed several job results from a first searching node 612, but only job results indicating a location of San Jose, Calif. The first query builder 802 may then include the predicate “San Jose” in the query.

Each searching node 612 returns job results to the respective search classification set ranker, shown here as a first classification ranker 808, a second classification ranker 810, and a third classification ranker 812. As in the method shown in FIG. 6B, the classification rankers 808, 810, 812 determine whether job characteristics from the job results cause the job results to be included in one or more search classification sets, and subsequently assign classification affinity scores to the search classification sets and rank the search classification sets based on the included job results.

At operation 814, the system receives the ranked search classification sets at the social networking server 120, merges the classification rankings (such as by using the classification affinity scores assigned to the search classification sets), and ranks the job results based on the ranking of the search classification sets. The social networking server 120 then delivers the ranked job results to the job application 152, which causes a user interface to display the job results to the member 160.

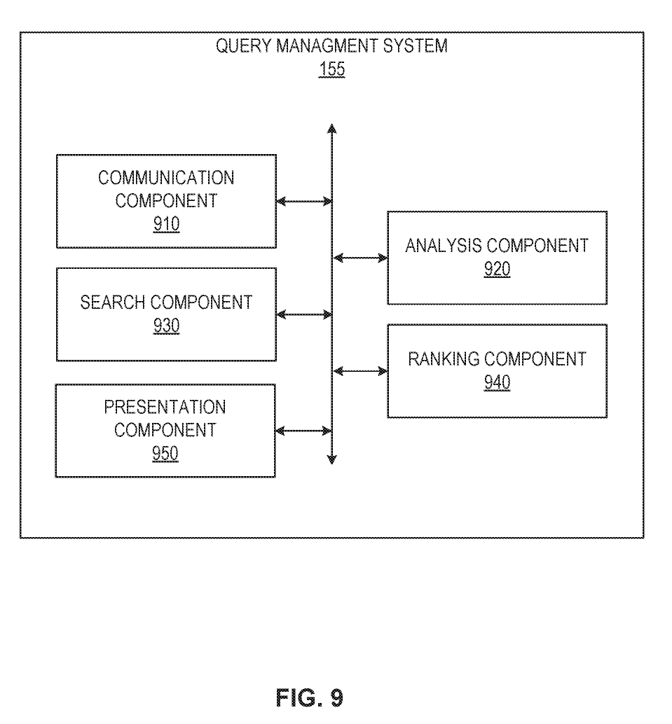

FIG. 9 illustrates the query manager 155 within a network architecture for implementing example embodiments. In one example embodiment, the query manager 155 includes a communication component 910, an analysis component 920, a scoring component 930, a ranking component 940, and a presentation component 950.

The communication component 910 provides various data retrieval and communications functionality. In example embodiments, the communication component 910 retrieves data from the databases 132, 128, 130, and 134, including member data, jobs, classification data, classification features 508, job features 506, and member features 504. The communication component 910 can further retrieve data from the databases 132, 128, 130, and 134 related to rules, such as threshold data.

The analysis component 920 performs various functions such as determining whether to apply a probabilistic Boolean predicate to a query object. Additionally, the analysis component 920 performs machine-learning programs 516 described in FIG. 5 to determine values for later scoring.

The scoring component 930 calculates the job affinity scores 406, member-classification scores 410, and classification affinity scores 408 as illustrated above with reference to FIGS. 4A-4B and 6A-6B. In an example, the scoring component 930 calculates classification affinity scores for search classification sets based on job results within each search classification.

The ranking component 940 provides functionality to rank search classification sets and job results based on the scores, as shown in the above embodiments and examples. In an example, the ranking component 940 generates a ranked list of search classification sets based on the classification affinity scores of the search classification sets.

The presentation component 950 provides functionality to present a display of job results to the member 160, such as on a user interface of the client device 150. The presentation component 950 may further present selectable options to the member 160, such as a favorite option.

It is to be noted that the embodiments illustrated in FIG. 9 are examples and do not describe every possible embodiment. Other embodiments may utilize different servers or additional servers, combine the functionality of two or more servers into a single server, utilize a distributed server pool, and so forth. The embodiments illustrated in FIG. 9 should therefore not be interpreted to be exclusive or limiting, but rather illustrative.

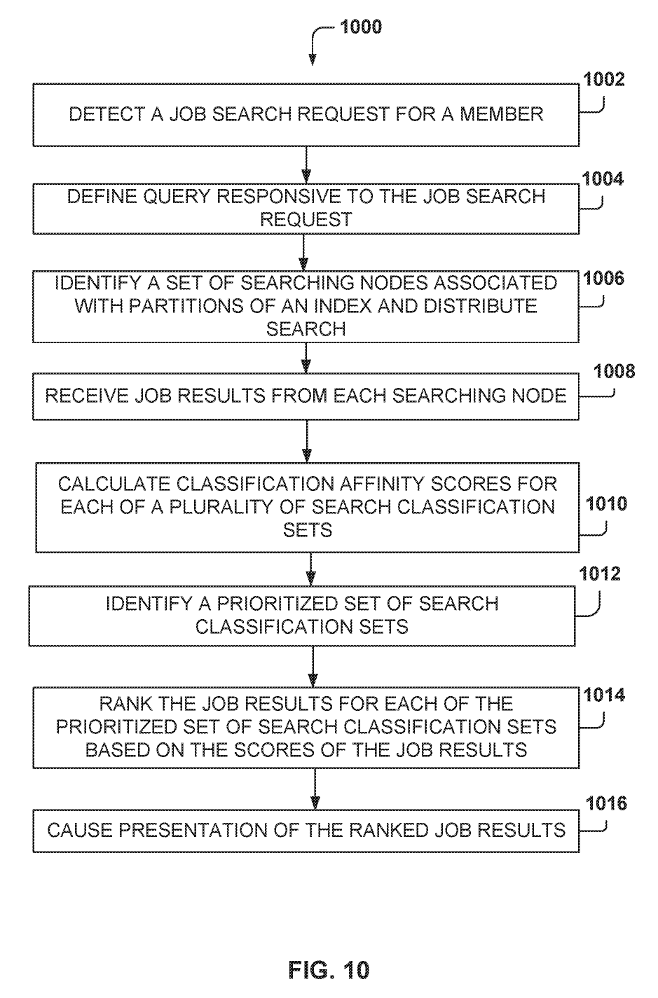

FIG. 10 is a flowchart of a method 1000, according to some example embodiments, for ranking job results based on search classification sets. While the various operations in this flowchart are presented and described sequentially, one of ordinary skill will appreciate that some or all of the operations may be executed in a different order, be combined or omitted, or be executed in parallel. Operation 1002 is for detecting, by a server having one or more processors, a search query requested for a member 160.

From operation 1002, the method 1000 flows to operation 1004, where the server defines a query object in response to the search query. From operation 1004, the method 1000 flows to operation 1006, where the server identifies searching nodes associated with partitions of an index and distributes the query object to the searching nodes. From operation 1006, the method 1000 flows to operation 1008 where the server receives job results from the searching nodes.

At operation 1010, in response to receiving the job results from the searching nodes, the server calculates a classification affinity score for each of a plurality of search classification sets based on a relevance of the job result to job characteristics associated with the search classification sets. In some embodiments, as shown above, the relevance of the job results to the job characteristics may be measured using a threshold value. In some example embodiments, the relevance of job results to job characteristics may be measured probabilistically, such as by the system using a machine-learning program 516 to determine a level of similarity between the job results and the job characteristics. From operation 1010, the method 1000 flows to operation 1012 where the system identifies a prioritized set of search classification sets based on the classification affinity scores of the search classification sets. From operation 1012, the method 1000 flows to operation 1014 where the system ranks the job results included in the prioritized set of search classification sets. Finally, at operation 1016, the server causes presentation of the ranked job results within a user interface, the position of the presentation based on the ranking of the job results.

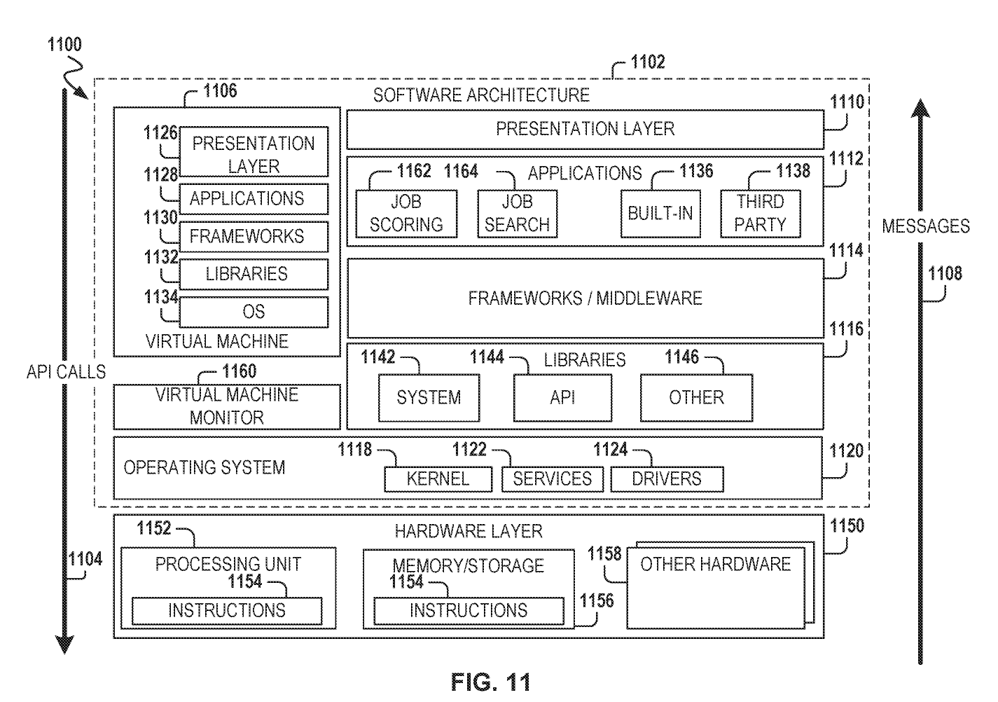

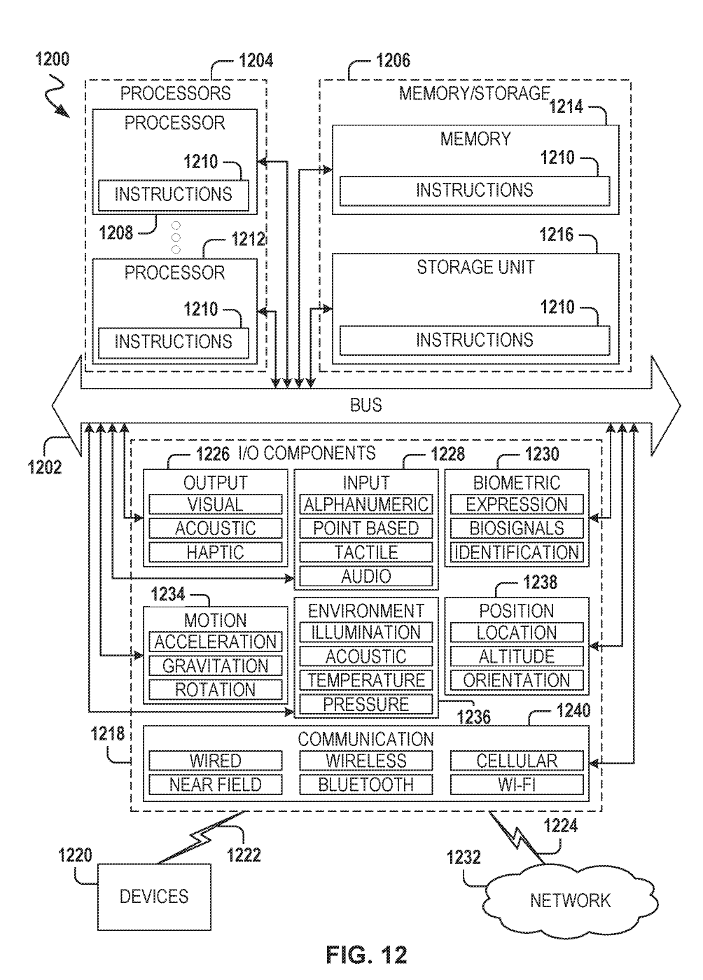

FIG. 11 is a block diagram 1100 illustrating a representative software architecture 1102, which may be used in conjunction with various hardware architectures herein described. FIG. 11 is merely a non-limiting example of a software architecture 1102, and it will be appreciated that many other architectures may be implemented to facilitate the functionality described herein. The software architecture 1102 may be executing on hardware such as a machine 1200 of FIG. 12 that includes, among other things, processors 1204, memory/storage 1206, and input/output (I/O) components 1218. A representative hardware layer 1150 is illustrated and can represent, for example, the machine 1200 of FIG. 12. The representative hardware layer 1150 comprises one or more processing units 1152 having associated executable instructions 1154. The executable instructions 1154 represent the executable instructions of the software architecture 1102, including implementation of the methods, modules, and so forth of FIGS. 1-6B, 8, and 10. The hardware layer 1150 also includes memory and/or storage modules 1156, which also have the executable instructions 1154. The hardware layer 1150 may also comprise other hardware 1158, which represents any other hardware of the hardware layer 1150, such as the other hardware illustrated as part of the machine 1200.

In the example architecture of FIG. 11, the software architecture 1102 may be conceptualized as a stack of layers where each layer provides particular functionality. For example, the software architecture 1102 may include layers such as an operating system 1120, libraries 1116, frameworks/middleware 1114, applications 1112, and a presentation layer 1110. Operationally, the applications 1112 and/or other components within the layers may invoke application programming interface (API) calls 1104 through the software stack and receive a response, returned values, and so forth illustrated as messages 1108 in response to the API calls 1104. The layers illustrated are representative in nature, and not all software architectures have all layers. For example, some mobile or special-purpose operating systems may not provide a frameworks/middleware 1114 layer, while others may provide such a layer. Other software architectures may include additional or different layers.

The operating system 1120 may manage hardware resources and provide common services. The operating system 1120 may include, for example, a kernel 1118, services 1122, and drivers 1124. The kernel 1118 may act as an abstraction layer between the hardware and the other software layers. For example, the kernel 1118 may be responsible for memory management, processor management (e.g., scheduling), component management, networking, security settings, and so on. The services 1122 may provide other common services for the other software layers. The drivers 1124 may be responsible for controlling or interfacing with the underlying hardware. For instance, the drivers 1124 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1116 may provide a common infrastructure that may be utilized by the applications 1112 and/or other components and/or layers. The libraries 1116 typically provide functionality that allows other software modules to perform tasks in an easier fashion than by interfacing directly with the underlying operating system 1120 functionality (e.g., kernel 1118, services 1122, and/or drivers 1124). The libraries 1116 may include system libraries 1142 (e.g., C standard library) that may provide functions such as memory allocation functions, string manipulation functions, mathematic functions, and the like. In addition, the libraries 1116 may include API libraries 1144 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1116 may also include a wide variety of other libraries 1146 to provide many other APIs to the applications 1112 and other software components/modules.

The frameworks 1114 (also sometimes referred to as middleware) may provide a higher-level common infrastructure that may be utilized by the applications 1112 and/or other software components/modules. For example, the frameworks 1114 may provide various graphic user interface (GUI) functions, high-level resource management, high-level location services, and so forth. The frameworks 1114 may provide a broad spectrum of other APIs that may be utilized by the applications 1112 and/or other software components/modules, some of which may be specific to a particular operating system or platform.

The applications 1112 include job-scoring applications 1162, job search/suggestion applications 1164, built-in applications 1136, and third-party applications 1138. The job-scoring applications 1162 comprise determination of the job affinity score 406 as shown in FIGS. 4A-4B as well as other job scoring with groups. Examples of representative built-in applications 1136 may include, but are not limited to, a contacts application, a browser application, a book reader application, a location application, a media application, a messaging application, and/or a game application. The third-party applications 1138 may include any of the built-in applications 1136 as well as a broad assortment of other applications. In a specific example, the third-party application 1138 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1138 may invoke the API calls 1104 provided by the mobile operating system such as the operating system 1120 to facilitate functionality described herein.

The applications 1112 may utilize built-in operating system functions (e.g., kernel 1118, services 1122, and/or drivers 1124), libraries (e.g., system libraries 1142, API libraries 1144, and other libraries 1146), or frameworks/middleware 1114 to create user interfaces to interact with users of the system. Alternatively, or additionally, in some systems, interactions with a user may occur through a presentation layer, such as the presentation layer 1110. In these systems, the application/module “logic” can be separated from the aspects of the application/module that interact with a user.

Some software architectures utilize virtual machines. In the example of FIG. 11, this is illustrated by a virtual machine 1106. A virtual machine creates a software environment where applications/modules can execute as if they were executing on a hardware machine (such as the machine 1200 of FIG. 12, for example). The virtual machine 1106 is hosted by a host operating system (e.g., operating system 1120 in FIG. 11) and typically, although not always, has a virtual machine monitor 1160, which manages the operation of the virtual machine 1106 as well as the interface with the host operating system (e.g., operating system 1120). A software architecture executes within the virtual machine 1106, such as an operating system 1134, libraries 1132, frameworks/middleware 1130, applications 1128, and/or a presentation layer 1126. These layers of software architecture executing within the virtual machine 1106 can be the same as corresponding layers previously described or may be different.

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1210 (e.g., software, a program, an application, an applet, an app, or other executable code) for causing the machine 1200 to perform any one or more of the methodologies discussed herein may be executed. For example, the instructions 1210 may cause the machine 1200 to execute the flow diagram of FIG. 10. Additionally, or alternatively, the instructions 1210 may implement the job-scoring programs and the machine-learning programs associated with it. The instructions 1210 transform the general, non-programmed machine 1200 into a particular machine 1200 programmed to carry out the described and illustrated functions in the manner described.

In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1210, sequentially or otherwise, that specify actions to be taken by the machine 1200. Further, while only a single machine 1200 is illustrated, the term “machine” shall also be taken to include a collection of machines 1200 that individually or jointly execute the instructions 1210 to perform any one or more of the methodologies discussed herein.

The machine 1200 may include processors 1204, memory/storage 1206, and I/O components 1218, which may be configured to communicate with each other such as via a bus 1202. In an example embodiment, the processors 1204 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 1208 and a processor 1212 that may execute the instructions 1210. The term “processor” is intended to include multi-core processors that may comprise two or more independent processors (sometimes referred to as “cores”) that may execute instructions contemporaneously. Although FIG. 12 shows multiple processors 1204, the machine 1200 may include a single processor with a single core, a single processor with multiple cores (e.g., a multi-core processor), multiple processors with a single core, multiple processors with multiples cores, or any combination thereof.

The memory/storage 1206 may include a memory 1214, such as a main memory, or other memory storage, and a storage unit 1216, both accessible to the processors 1204 such as via the bus 1202. The storage unit 1216 and memory 1214 store the instructions 1210 embodying any one or more of the methodologies or functions described herein. The instructions 1210 may also reside, completely or partially, within the memory 1214, within the storage unit 1216, within at least one of the processors 1204 (e.g., within the processor's cache memory), or any suitable combination thereof, during execution thereof by the machine 1200. Accordingly, the memory 1214, the storage unit 1216, and the memory of the processors 1204 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store the instructions 1210. The term “machine-readable medium” shall also be taken to include any medium, or combination of multiple media, that is capable of storing instructions (e.g., instructions 1210) for execution by a machine (e.g., machine 1200), such that the instructions, when executed by one or more processors of the machine (e.g., processors 1204), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1218 may include a wide variety of components to receive input, provide output, produce output, transmit information, exchange information, capture measurements, and so on. The specific I/O components 1218 that are included in a particular machine will depend on the type of machine. For example, portable machines such as mobile phones will likely include a touch input device or other such input mechanisms, while a headless server machine will likely not include such a touch input device. It will be appreciated that the I/O components 1218 may include many other components that are not shown in FIG. 12. The I/O components 1218 are grouped according to functionality merely for simplifying the following discussion, and the grouping is in no way limiting. In various example embodiments, the I/O components 1218 may include output components 1226 and input components 1228. The output components 1226 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1228 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1218 may include biometric components 1230, motion components 1234, environmental components 1236, or position components 1238 among a wide array of other components. For example, the biometric components 1230 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 may include acceleration sensor components (e.g., accelerometer), gravitation sensor components, rotation sensor components (e.g., gyroscope), and so forth. The environmental components 1236 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1238 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1218 may include communication components 1240 operable to couple the machine 1200 to a network 1232 or devices 1220 via a coupling 1224 and a coupling 1222, respectively. For example, the communication components 1240 may include a network interface component or other suitable device to interface with the network 1232. In further examples, the communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1220 may be another machine or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geo-location, location via Wi-Fi® signal triangulation, location via detecting an NFC beacon signal that may indicate a particular location, and so forth.

In various example embodiments, one or more portions of the network 1232 may be an ad hoc network, an intranet, an extranet, a virtual private network (VPN), a local-area network (LAN), a wireless LAN (WLAN), a wide-area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1232 or a portion of the network 1232 may include a wireless or cellular network and the coupling 1224 may be a Code Division Multiple Access (CDMA) connection, a Global System for Mobile communications (GSM) connection, or another type of cellular or wireless coupling. In this example, the coupling 1224 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1210 may be transmitted or received over the network 1232 using a transmission medium via a network interface device (e.g., a network interface component included in the communication components 1240) and utilizing any one of a number of well-known transfer protocols (e.g., hypertext transfer protocol (HTTP)). Similarly, the instructions 1210 may be transmitted or received using a transmission medium via the coupling 1222 (e.g., a peer-to-peer coupling) to the devices 1220. The term “transmission medium” shall be taken to include any intangible medium that is capable of storing, encoding, or carrying the instructions 1210 for execution by the machine 1200, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
detecting, by one or more processors, a job search request for a member of a social network;
defining a query object based on the job search request;
identifying a set of searching nodes for distributing the job search request, each searching node being associated with a partition of an index of a jobs database;
sending the query object to the set of searching nodes;
receiving job results from each searching node;
calculating a classification affinity score for each of a plurality of search classification sets, each classification affinity score being based on a relevance of the job results to job characteristics associated with the respective search classification;
identifying a prioritized set of search classification sets based on the classification affinity scores of the job results for each of the search classification sets;
ranking the job results for each of the prioritized set of search classification sets based on the classification affinity scores of the job results for each of the prioritized set of search classification sets; and
causing a presentation of the ranked job results in a user interface of the member.

2. The method of claim 1, wherein the defining the query object further includes identifying at least one Boolean predicate, the Boolean predicate being one or more logical terms included in the query.

3. The method of claim 2, wherein the at least one Boolean predicate includes a probabilistic weight based on a weighting equation to that indicates a degree of consideration of the Boolean predicate in the query.

4. The method of claim 2, wherein the identifying of at least one Boolean predicate is based on a deterministic threshold based on a value within the member data about the member profile, the Boolean predicate being identified in response to the deterministic threshold being exceeded by the value within the member data.

5. The method of claim 1, wherein the classification affinity score between the job result and the respective search classification set is calculated by a machine-learning program.

6. The method of claim 1, wherein each job result includes a job affinity score based on a matching degree between the member profile of the member and the job result.

7. The method of claim 6, wherein the matching degree between the member profile of the member and the job result is calculated by a machine-learning program.

8. The method of claim 1, further comprising:
calculating a member-classification score between the member and each of the plurality of search classification sets, the member-classification score based on a measure of similarity between the member and the respective search classification set, and wherein identifying the prioritized set of search classification sets is further based on the member-classification score of each of the search classification sets.

9. The method of claim 8, wherein the member-classification score between the member and each of the plurality of search classification sets is calculated by a machine-learning program.

10. A system comprising:
at least one processor of a machine; and
a memory storing instructions that, when executed by the at least one processor, cause the machine to perform operations comprising:
detecting, by one or more processors, a job search request for a member of a social network;
defining a query object based on the job search request;
identifying a set of searching nodes for distributing the job search request, each searching node being associated with a partition of an index of a jobs database;
sending the query object to the set of searching nodes;
receiving job results from each searching node;
calculating a classification affinity score for each of a plurality of search classification sets, each classification affinity score being based on a relevance of the job results to job characteristics associated with the respective search classification;
identifying a prioritized set of search classification sets based on the classification affinity scores of the job results for each of the search classification sets;
ranking the job results for each of the prioritized set of search classification sets based on the classification affinity scores of the job results for each of the prioritized set of search classification sets; and
causing a presentation of the ranked job results in a user interface of the member.

11. The system of claim 10, wherein the defining the query object further includes identifying at least one Boolean predicate, the Boolean predicate being one or more logical terms included in the query.

12. The system of claim 11, wherein the at least one Boolean predicate includes a probabilistic weight based on a weighting equation to that indicates a degree of consideration of the Boolean predicate in the query.

13. The system of claim 11, wherein the identifying of at least one Boolean predicate is based on a deterministic threshold based on a value within the member data about the member profile, the Boolean predicate being identified in response to the deterministic threshold being exceeded by the value within the member data.

14. The system of claim 10, wherein the classification affinity score between the job result and the respective search classification set is calculated by a machine-learning program.

15. The system of claim 10, wherein each job result includes a job affinity score based on a matching degree between the member profile of the member and the job result.

16. The system of claim 15, wherein the matching degree between the member profile of the member and the job result is calculated by a machine-learning program.

17. The system of claim 10, wherein the operations further comprise:
calculating a member-classification score between the member and each of the plurality of search classification sets, the member-classification score based on a measure of similarity between the member and the respective search classification set, and wherein identifying the prioritized set of search classification sets is further based on the member-classification score of each of the search classification sets.

18. The system of claim 17, wherein the member-classification score between the member and each of the plurality of search classification sets is calculated by a machine-learning program.

19. A non-transitory machine-readable storage medium comprising instructions that, when executed by one or more processors of a machine, cause the machine to perform operations comprising:
detecting, by one or more processors, a job search request for a member of a social network;
defining a query object based on the job search request;
identifying a set of searching nodes for distributing the job search request, each searching node being associated with a partition of an index of a jobs database;
sending the query object to the set of searching nodes;
receiving job results from each searching node;
calculating a classification affinity score for each of a plurality of search classification sets, each classification affinity score being based on a relevance of the job results to job characteristics associated with the respective search classification;
identifying a prioritized set of search classification sets based on the classification affinity scores of the job results for each of the search classification sets;
ranking the job results for each of the prioritized set of search classification sets based on the classification affinity scores of the job results for each of the prioritized set of search classification sets; and
causing a presentation of the ranked job results in a user interface of the member.

20. The non-transitory machine-readable storage medium of claim 19, wherein the at least one Boolean predicate includes a probabilistic weight based on a weighting equation to that indicates a degree of consideration of the Boolean predicate in the query.
